(19) United States
(12) Patent Application Publication
(10) Pub. No.: US 2012/0128816 A1
(43) Pub. Date: May 24, 2012

(54) METHOD OF PROCESSING CEREAL GRAIN WITH LACTIC ACID FOR USE IN RUMINANT FEED

(75) Inventor: Burim Ametaj, Edmonton (CA)

(73) Assignee: GOVERNORS OF THE UNIVERSITY OF ALBERTA, Edmonton, AB (CA)

(21) Appl. No.: 13/382,390

(22) PCT Filed: Jul. 13, 2010
(86) PCT No.: PCT/CA10/01106

§ 371 Date: Feb. 9, 2012

Related U.S. Application Data
(60) Provisional application No. 61/224,978, filed on Jul. 13, 2009.

(51) Int. Cl. A23K 1/18

(52) U.S. Cl. 426/2; 426/623

(57) ABSTRACT

A method of producing a ruminant feed includes cereal grain treated with a weak organic acid such as lactic acid, and optionally heated. The ruminant feed is suitable feed for dairy cows which may benefit from increased ruminal pH and increased milk fat production.

### FIELD OF THE INVENTION

This invention relates to a method of processing cereal grain using lactic acid for use in ruminant feed, ruminant feeds comprising the treated cereal grain; and methods of feeding these feeds to ruminants.

### BACKGROUND OF THE INVENTION

Ruminants are mammals which possess a special digestive organ, the rumen, within which efficient digestion of plant fiber occurs through the activity of anaerobic microorganisms. Ruminants subsist primarily on plant fiber derived from grasses and legumes, which consists mostly of insoluble polysaccharides, particularly cellulose and hemicellulose. While most mammals lack the enzymes necessary to digest such polysaccharides, ruminants rely upon microorganisms as digestive agents. While food remains in the rumen, cellulolytic microorganisms hydrolyze cellulose to the disaccharide cellobiose and to free glucose units. The released glucose then undergoes a bacterial fermentation with the production of volatile fatty acids and gases. The volatile fatty acids travel across the rumen wall to the bloodstream and are oxidized by the ruminant as its main source of energy. Carbon dioxide and methane are removed by eructation to the atmosphere. In addition, the microorganisms synthesize amino acids and vitamins. Although the rumen is an efficient mechanism for digestion, this process is slow and often incomplete. This inefficiency leads to increased cost of livestock production, increased use of feed resources, and increased environmental impact of ruminant production.

Since lactating dairy cows require large amounts of dietary energy for maintenance, milk production, and reproduction, barley grain is widely included in rations as a cost-effective digestible energy source. However, barley grain contains high amounts of rapidly digestible starch which is associated with the release of large amounts of volatile fatty acids in the rumen fluid, and a subsequent decrease in the rumen pH below 6 (Yang et al., 1997; Emmanuel et al., 2008). Maintenance of rumen pH above 6 is critical for the activity of microbiota and prevention of sub-acute rumen acidosis (SARA) (Krause and Oetzel, 2006; Zebeli et al., 2008). Development of SARA is associated with impaired cellulose digestion, lowered nutrient utilization, and the death of Gram-negative bacteria which subsequently release endotoxin (Ametaj et al., 2005; Emmanuel et al., 2007; Nocek, 1997; Stone, 2004). Endotoxin translocates into the blood circulation causing multiple metabolic and immune perturbations (for example, acidosis, fatty liver, laminitis, liver abscesses, infertility, displaced abomasum, bloat), and a decrease in the milk fat content in lactating dairy cows (Ametaj, 2005; Emmanuel et al., 2008; Zebeli and Ametaj, 2009).

The potential of high-grain diets to cause SARA can be alleviated by decreasing the amount of starch available for degradation or by increasing the quantity of starch that bypasses rumen degradation (Zebeli et al., 2008). Approaches to treat cereal grain using mechanical or thermal processing techniques (for example, pelleting, roasting, rolling, or steam heating) or chemical treatments (for example, sodium hydroxide, aldehyde, ammonia, fibrolytic enzymes) can be undesirable due to expense and danger posed to humans and the environment (Dehghan-Banadaky et al., 2007).

Recent in vitro and in vivo human studies have demonstrated that mild, non-corrosive organic acids or their salts, such as sodium propionate and calcium lactate, modify the structure of starch molecules imparting resistance against amylolytic attack (Liljeberg et al., 1995). Bread treated with lactic acid improves glycemic index, lowers cholesterol levels, and lowers the rate of starch digestion in humans by decreasing the rate of amylolysis (Ostman et al., 2002). Treatment of chemically processed cereal grain with moderate heat modifies starch structure and generates resistant starch which escapes digestion in the upper part of the gastrointestinal tract to be fully digested in the large intestine (Schmiedl et al., 2000). Treatment of starch with lactic acid increases starch recovery rates in corn grain by facilitating separation of starch granules from the protein matrix (Perez et al., 2001; Ostman et al., 2002). Steeping cereal grains in lactic acid slows down the rate of starch degradation in vitro and improves starch recovery (Dailey, 2002). However, there have not been any similar studies on livestock animals.

Therefore, an alternative treatment of cereal grain for use in animal feed is desirable to enhance the health and productivity of the animal and reduce the costs of production.

### SUMMARY OF THE INVENTION

The present invention relates to a method of processing cereal grain using a weak organic acid, for use in ruminant feed, particularly feed for dairy cows. In addition, the invention relates to ruminant feeds comprising the treated cereal grain; and methods for achieving desirable effects by feeding these feeds to ruminants.

In one aspect, the invention comprises a method of processing cereal grain for use in ruminant feed comprising treating the cereal grain with a weak organic acid. In one embodiment, the cereal grain is treated with a solution comprising 0.5% to 1.0% by volume of the acid and optionally heating the cereal grain, such as at a temperature of 55° C. In one embodiment, the cereal grain is heated for 48 hours. In one embodiment, the cereal grain comprises barley, wheat, corn, oats, sorghum, or millet. In one embodiment, the cereal grain is barley. In one embodiment, the cereal grain is admixed with one or more ingredients suitable for ruminant feed such as fibrous cellulosic materials, forage, legume forage, nitrogen sources, protein precursors, high energy sources, flavorings, vitamins, or minerals. In one embodiment, the cereal grain comprises 1-35% in dry matter of the ruminant feed. In one embodiment, the cereal grain comprises 25% to 35% in dry matter of the ruminant feed.

In one aspect, the invention comprises a ruminant feed comprising a cereal grain which has been treated with a weak organic acid as described herein.

In another aspect, the invention comprises a method of feeding a ruminant animal comprising administering to the animal the ruminant feed comprising a cereal grain which has been treated with a weak organic acid as described herein.

In yet another aspect, the invention comprises a method of preventing rumen acidosis and/or increasing milk fat content in a dairy cow comprising:
a) treating a cereal grain with a solution comprising 0.5% to 1.0% by volume of a weak organic acid;
b) optionally, heating the cereal grain at a temperature of 55° C.; and
c) administering the cereal grain to the dairy cow, wherein a decrease in rumen pH and/or an increase in milk fat content are effected.

In one embodiment, the cereal grain is heated for 48 hours. In one embodiment, the cereal grain is selected from barley, wheat, corn, oats, sorghum, or millet. In one embodiment, the cereal grain is barley. In one embodiment, the cereal grain is admixed with one or more ingredients selected from fibrous cellulosic materials, forage, legume forage, nitrogen sources, protein precursors, high energy sources, flavorings, vitamins, or minerals. In one embodiment, the cereal grain comprises 1-35% in dry matter. In one embodiment, the cereal grain comprises 25% to 35% in dry matter.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 shows a graph of the day-to-day variation of total volatile fatty acids (VFA) concentration in rumen fluid of lactating Holstein cows fed rolled barley grain steeped in tap water (CTR; ⋄) or in 0.5% lactic acid (TRT; ▪) solution (LSM+SEM; n=8).

FIG. 2 shows a graph of the diurnal variation of total VFA concentration in the rumen fluid of lactating Holstein cows fed diets based on rolled barley grain steeped in tap water (CTR; ⋄) or in 0.5% lactic acid (TRT; ▪) solution (LSM±SEM, n=8).

FIG. 3 shows a graph of the diurnal variation of rumen pH in lactating Holstein cows fed diets based on rolled barley grain steeped in tap water (CTR; ⋄) or in 0.5% lactic acid (TRT; ▪) solution (LSM±SEM; n=8).

FIG. 4 shows a graph of in situ dry matter disappearance in the rumen of lactating Holstein cows fed diets based on rolled barley grain steeped in tap water (control) for 48 h or in lactic acid (0.5% or 1.0% v/v) solution.

FIG. 5 shows a graph of milk fat content (%) in lactating Holstein cows fed diets based on rolled barley grain steeped in tap water (control) or in 1.0% lactic acid solution.

FIG. 6 shows a graph of in situ DM disappearance in the rumen of lactating Holstein cows fed diets based on rolled barley grain steeped in tap water (control; □) for 48 h or in lactic acid (1.0% v/v) solution and oven-heated for 48 h at 55° C. (LA-heat; ▪).

FIG. 7 shows a graph of diurnal variation of rumen pH in lactating Holstein cows fed diets based on rolled barley grain steeped in tap water (control; □) or in 1.0% lactic acid (LA-heat; ▪) solution (LSM±SEM, n=8).

FIG. 8 shows a graph of day-to-day pre-prandial rumen pH in lactating Holstein cows fed diets based on rolled barley grain steeped in tap water (control; □) or in 1.0% lactic acid (LA-heat; ▪) solution (LSM±SEM, n=8).

FIG. 9 shows a graph of day-to-day variations in dry matter intake in lactating Holstein cows fed diets based on rolled barley grain steeped in tap water (control; □) or in 1.0% lactic acid (LA-heat; ▪) solution (LSM±SEM, n=8).

FIG. 10 shows a graph of day-to-day variations in fat-corrected milk (kg/d) in lactating Holstein cows fed diets based on rolled barley grain steeped in tap water (control; □) or in 1.0% lactic acid (LA-heat; ▪) solution (LSM±SEM, n=8).

FIG. 11 shows a graph of day-to-day variations in the concentration of plasma cholesterol in lactating Holstein cows fed diets based on rolled barley grain steeped in tap water (control; □) or in 1.0% lactic acid (LA-heat; N) solution (LSM±SEM, n=8).

FIG. 12 shows a graph of day-to-day variations in the concentration of plasma lactate in lactating Holstein cows fed diets based on rolled barley grain steeped in tap water (control; □) or in 1.0% lactic acid (LA-heat; ▪) solution (LSM±SEM, n=8).

FIG. 13 shows a graph of day-to-day variations in the concentration of plasma beta-hydroxybutyric acid in lactating Holstein cows fed diets based on rolled barley grain steeped in tap water (control; □) or in 1.0% lactic acid (LA-heat; ▪) solution (LSM±SEM, n=8).

FIG. 14 shows a graph of day-to-day variations in the concentration of plasma glucose in lactating Holstein cows fed diets based on rolled barley grain steeped in tap water (control; □) or in 1.0% lactic acid (LA-heat; ▪) solution (LSM±SEM, n=8).

FIG. 15 shows a graph of day-to-day variations in concentration of plasma non-esterified fatty acids in lactating Holstein cows fed diets based on rolled barley grain steeped in tap water (control; □) or in 1.0% lactic acid (LA-heat; ▪) solution (LSM±SEM, n=8).

FIG. 16 shows a graph of diurnal variations in proportions of rumen acetate to propionate in lactating Holstein cows fed diets based on rolled barley grain steeped in tap water (control; □) or in 1.0% lactic acid (LA-heat; ▪) solution (LSM±SEM, n=8).

FIG. 17 shows a graph of diurnal variations in proportions of rumen butyrate in lactating Holstein cows fed diets based on rolled barley grain steeped in tap water (control; □) or in 1.0% lactic acid (LA-heat; ▪) solution (LSM±SEM, n=8).

FIG. 18 shows a graph of milk fat content (%) in lactating Holstein cows fed diets based on rolled barley grain steeped in tap water (control) or in 1.0% lactic acid (LA-heat) solution (LSM±SEM, n=8).

FIG. 19 shows a graph of milk lactose content (%) in lactating Holstein cows fed diets based on rolled barley grain steeped in tap water (control) or in 1.0% lactic acid (LA-heat) solution (LSM±SEM, n=8).

FIG. 20 shows a graph of milk protein content (%) in lactating Holstein cows fed diets based on rolled barley grain steeped in tap water (control) or in 1.0% lactic acid (LA-heat) solution (LSM±SEM, n=8).

FIG. 21 shows a graph of milk fat yield (kg/d) in lactating Holstein cows fed diets based on rolled barley grain steeped in tap water (control) or in 1.0% lactic acid (LA-heat) solution (LSM±SEM, n=8).

FIG. 22 shows a graph of fat energy corrected milk (kg/d) in lactating Holstein cows fed diets based on rolled barley grain steeped in tap water (control) or in 1.0% lactic acid (LA-heat) solution (LSM±SEM, n=8).

FIG. 23 shows a graph of milk urea nitrogen (mg/dL) in lactating Holstein cows fed diets based on rolled barley grain steeped in tap water (control) or in 1.0% lactic acid (LA-heat solution (LSM±SEM, n=8).

FIG. 24 shows a graph of milk energy efficiency (g fat/kg dry matter intake) in lactating Holstein cows fed diets based on rolled barley grain steeped in tap water (control) or in 1.0% lactic acid (LA-heat) solution (LSM±SEM, n=8).

FIG. 25 shows a graph of diurnal variations in the concentration of plasma glucose in late-lactation Holstein cows fed diets based on rolled barley grain steeped in tap water (control) or in 1.0% lactic acid (LA-heat) solution.

FIG. 26 shows a graph of diurnal variations in the concentration of plasma beta-hydroxybutyric acid in late-lactation Holstein cows fed diets based on rolled barley grain steeped in tap water (control) or in 1.0% lactic acid (LA-heat) solution.

FIG. 27 shows a graph of diurnal variations in concentration of plasma non-esterified fatty acids in late-lactation Holstein cows fed diets based on rolled barley grain steeped in tap water (control) or in 1.0% lactic acid (LA-heat) solution.

FIG. 28 shows a graph of diurnal variations in the concentration of plasma lactate in late-lactation Holstein cows fed diets based on rolled barley grain steeped in tap water (control) or in 1.0% lactic acid (LA-heat) solution.

FIG. 29 shows a graph of diurnal variations in the concentration of plasma cholesterol in late-lactation Holstein cows fed diets based on rolled barley grain steeped in tap water (control) or in 1.0% lactic acid (LA-heat) solution.

### DETAILED DESCRIPTION OF PREFERRED EMBODIMENTS

When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

To facilitate understanding of the invention, the following definitions are provided.

The term “ruminant” or “ruminants” is meant to include cattle, sheep, goats, camels, buffalo, deer, reindeer, caribou and elk which have a complex, multi-chambered stomach. The term “rumen” means the largest compartment of the stomach of a ruminant.

The term “dairy cow” means a domesticated animal bred to produce milk including, but not limited to, a breed such as Holstein-Friesian, Red and White Holstein, Brown Swiss, Guernsey, Ayrshire, Jersey, and Milking Shorthorn.

The term “feed” means a forage or cereal grain feed or combination thereof.

The terms “cereal,” “cereal grain,” or “grain” mean the seeds of plants (such as grasses or members of the monocot families Poaceae or Gramineae) which are typically fed to ruminant animals which may or may not include the outer hull, pod or husk of the seed. Examples of cereal grain feed include, without limitation, barley, wheat, corn, oats, sorghum, millet, triticale, rye, and oilseeds.

The term “forage” means the edible parts of plants, other than separated grains, which can provide feed for grazing animals or that can be harvested for feeding to ruminants.

The term “legume forage” means the portion of a plant used as an animal feedstuff which is a dicotyledonous plant species that is a member of the botanical family Leguminosae. Examples include, without limitation, alfalfa, sainfoin, clover and vetches.

The term “total mixed ration” abbreviated as “TMR” means a combination of two or more feed materials.

The term “dry matter” abbreviated as “DM” means the substance in a plant remaining after oven drying to constant weight.

The term “beta-hydroxybutyric acid” abbreviated as “BHBA” means a ketone body with a chemical formula of C₄H₈O₃.

The term “weak organic acid” means any C1-7 organic acids, or their sodium, potassium and calcium salts, which are known in the art as a food grade acids for application in nutrition or animal feed. Weak acids are only partially ionized when dissolved in water and have pKa values in approximate range of about 2 to about 12 in water. Weak organic acids include acetic acid, ascorbic acid, citric acid, lactic acid, malic acid, sorbic acid and tartaric acid.

The term “lactic acid” means 2-hydroxypropanoic acid which is a carboxylic acid with a chemical formula of C₃H₆O₃.

The term “non-esterified fatty acids” abbreviated as “NEFA” means the fraction of plasma fatty acids not in the form of glycerol esters.

The term “volatile fatty acids” abbreviated a “VFA” are the end products of microbial fermentation in the rumen and provide energy to the ruminant animal. VFA includes, but is not limited to, acetic, propionic and butyric acids.

The present invention relates to a method of processing cereal grain using a weak organic acid, such as lactic acid, to produce a ruminant feed, particularly feed for dairy cows; ruminant feeds comprising the treated cereal grain; and methods for feeding these feeds to ruminants. In the case of dairy cows, these feeds are particularly advantageous during lactation when the energy requirements of the cows are greatest.

In one embodiment, the invention comprises a method of processing cereal grain for use in ruminant feed comprising treating cereal grain with a solution of a weak organic acid. In one embodiment, the cereal grain is treated with an aqueous solution comprising about 0.5% or more by volume of the acid. In another embodiment, the cereal grain is treated with an aqueous solution comprising 1% by volume or less of the acid.

The weak organic acid is preferably a food grade acid, which are suitable for use in nutrition and animal feed. Suitable examples include acetic acid, ascorbic acid, citric acid, lactic acid, malic acid, sorbic acid and tartaric acid. In one embodiment, lactic acid is a preferred weak organic acid.

In one embodiment, the treatment with the weak organic acid is accomplished by steeping the cereal grain in a volume of an aqueous solution of the acid. For example, a 5 kg portion of cereal grain may be steeped in 5 litres of aqueous lactic acid.

The cereal grain may be steeped for an extended period of time, for example, 6 hours or longer. In one embodiment, the cereal grain may be steeped for a length of time between about 24 hours and about 48 hours.

In one embodiment, the cereal grain may be heated after treatment with the weak organic acid, such as at a temperature of greater than 30° C., 40°, or 50° C. The heating step may be for 6 hours or longer. For example, the treated cereal grain may be heated for 12 hours, 24 hours, or 48 hours, or longer. In one embodiment, the cereal grain is heated at 55° C. for 48 hours.

In one embodiment, the invention comprises a method of preventing rumen acidosis and/or increasing milk fat content in a dairy cow comprising:
a) treating a cereal grain with a solution comprising 0.5% to 1.0% by volume of a weak organic acid;
b) optionally, heating the cereal grain; and
c) administering the cereal grain to the dairy cow, wherein a decrease in rumen pH and/or an increase in milk fat content are effected.

Ruminant animals include, but are not limited to, cattle, sheep, goats, camels, buffalo, deer, reindeer, caribou and elk. In one embodiment, the ruminant animal is a dairy cow including, but not limited to, a breed such as Holstein-Friesian, Red and White Holstein, Brown Swiss, Guernsey, Ayrshire, Jersey, and Milking Shorthorn.

In one embodiment, the ruminant feed comprises a cereal grain treated with a solution comprising 0.5% to 1.0% by volume of lactic acid, and optionally heated at a temperature of 55° C. In one embodiment, the treated cereal grain is heated for 48 hours. In one embodiment, the cereal grain is selected from barley, wheat, corn, oats, sorghum, or millet. In one embodiment, the cereal grain is barley.

The composition of the ruminant feed may vary depending on the breed, age, sex, and stage of lactation of the animal; the season of the year; and the cost and availability of other ingredients. However, a typical ruminant feed of this invention comprises the treated cereal grain mixed with other conventional ruminant feed ingredients including, but not limited to, fibrous, cellulosic material digestible by ruminants, such as, silage, crop by-products, fibrous plant matter, roughage, forage, or legume forage (hay, alfalfa, clover, etc.); conventional nitrogen sources and protein precursors (fish meal, soybean meal, cottonseed meal, linseed meal, canola meal, nitrogen compounds, etc.); high energy sources and flavorings, such as molasses; vitamins; and minerals. In one embodiment, the ruminant feed comprises 1-35% treated cereal grain dry matter (of the total mixed ration). In one embodiment, the treated cereal grain comprises 25% to 35% in dry matter of the total mixed ration.

In another embodiment, feeding ruminant feed which comprises a cereal grain treated with a weak organic acid to dairy cows appears to improve rumen feimentation patterns, increase milk fat production, increase overall productivity of dairy cows, and/or to lower the risk of SARA. Without restriction to a theory, it is believed that such beneficial effects are achieved by the modulation of the starch degradation characteristics of the cereal grain.

In the development of embodiments of the invention, in vivo and in situ trials were conducted to determine the effects of barley grain steeped in lactic acid, or barley grain which has been steeped in lactic acid and heated, upon rumen fermentation patterns, in situ dry matter (DM) degradation kinetics, and milk production and composition in lactating dairy cows. As described below, Experiment 1 determined the effects of feeding rolled barley grain treated with lactic acid upon rumen acidosis and milk fat content. Experiment 2 determined the effects of feeding rolled barley grain treated with lactic acid and heat upon rumen acidosis, increased milk fat content, and day-to-day or diurnal patterns of plasma metabolites.

Experiment 1 involved in vivo trials comprising two experiments with eight rumen-fistulated Holstein cows each. Cows were fed once daily a total mixed ration containing rolled barley grain (27% in DM) steeped for 48 hours in tap water by weight (control or CTR) or in 0.5% lactic acid (treatment or TRT) in a 2×2 crossover design. The rolled barley grain was steeped in both cases in a proportion of 1 kg per liter of fluid. The in situ trials involved incubation of untreated rolled barley grain in cows fed the control or lactic acid-treated diet, and incubation of three different substrates including control or barley grain steeped in 0.5% or 1.0% lactic acid (TRT1 and TRT2, respectively) up to 72 hours in the rumen.

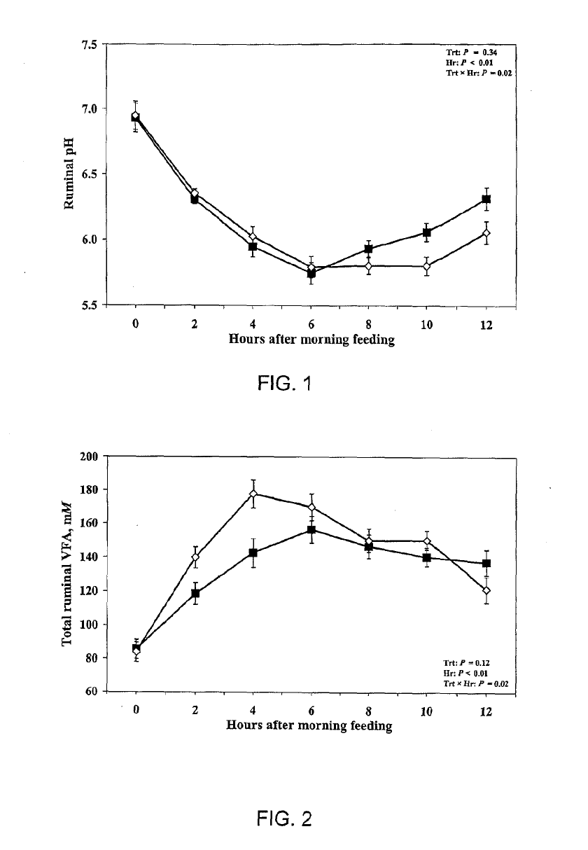

Steeping barley grain in 0.5% lactic acid improved the rumen fermentation profile and lowered the risk of SARA. Results of the in vivo trial indicated that cows fed the lactic acid-treated diet maintained greater rumen pH during the most intensive fermentation phases at 10 hours (P=0.02) and 12 hours (P=0.04) post-feeding (FIG. 1). Cows fed the lactic acid-treated diet had shorter time (2.4 hours) in which the rumen pH was below 5.8 compared to the control group (3.9 hours; P=0.04; Table 1). Maintenance of rumen pH above 5.8, during the postprandial intensive fermentation phases, is critical for the activity of rumen microbiota and prevention of SARA.

TABLE 1
Data of diurnal pH and concentrations of VFA in the rumen
fluid of lactating cows fed two different diets

| | Diets¹ | | | Effect,² P-value | | |
|---|---|---|---|---|---|---|
| Items | CTR | TRT | SEM | Trt | Hr | Trt × Hr |
| Time ruminal pH <5.8, h | 3.94 | 2.39 | 0.97 | 0.04 | — | — |
| Individual VFA³ | | | | | | |
| mM | | | | | | |
| Acetate | 80.1 | 74.5 | 2.36 | 0.11 | <0.01 | 0.03 |
| Propionate | 27.6 | 26.3 | 0.87 | 0.32 | <0.01 | 0.09 |
| Butyrate | 24.8 | 22.3 | 0.80 | 0.04 | <0.01 | 0.01 |
| Isobutyrate | 1.46 | 1.33 | 0.06 | 0.16 | <0.01 | 0.01 |
| Valerate | 4.14 | 4.42 | 0.63 | 0.76 | <0.01 | 0.02 |
| Isovalerate | 2.60 | 1.93 | 0.20 | 0.04 | <0.01 | 0.03 |
| Caproate | 1.11 | 1.67 | 0.24 | 0.12 | <0.01 | 0.14 |
| % of total VFA | | | | | | |
| Acetate (A) | 57.2 | 56.8 | 0.70 | 0.69 | <0.01 | 0.62 |
| Propionate (P) | 19.5 | 19.9 | 0.37 | 0.42 | 0.27 | 0.92 |
| Butyrate | 16.9 | 16.4 | 0.43 | 0.44 | <0.01 | 0.33 |
| Isobutyrate | 1.04 | 1.03 | 0.03 | 0.86 | <0.01 | 0.02 |
| Valerate | 2.80 | 3.20 | 0.41 | 0.49 | <0.01 | 0.02 |
| Isovalerate | 1.84 | 1.48 | 0.14 | 0.10 | <0.01 | 0.51 |
| Caproate | 0.75 | 1.17 | 0.15 | 0.07 | <0.01 | 0.12 |
| A:P | 2.95 | 2.89 | 0.08 | 0.59 | 0.06 | 0.88 |

¹CTR = control diet containing rolled barley grain steeped for 48 h in equal quantity of tap water; TRT = treatment diet based on rolled barley grain steeped for 48 h in equal quantity of tap water containing 0.5% lactic acid (v/v).
²Effect of dietary treatment (Trt), measurement hour (Hr), and treatment by hour interaction (Trt × Hr).
³Data across 0, 2, 4, 8, 10, and 12 h post-feeding (n = 8).

The positive effect of lactic acid-treated barley grain on rumen pH was reflected by the results of the in situ trial and the concentration of volatile fatty acids in the rumen fluid. Diurnal fluctuations related to concentration of total rumen volatile fatty acids are shown in FIG. 2, whereas concentrations and molar percentages of individual volatile fatty acids are presented in Table 1. Results showed an interaction between the diet and the hour of measurement for total volatile fatty acids (P=0.02; FIG. 2). Thus, cows fed the control diet showed greater concentration of volatile fatty acids, particularly at 2 hours and 4 hours post-feeding (P=0.03 and P=0.01). Diurnal data indicated that molar proportions of major volatile fatty acids in the rumen fluid including acetate and butyrate were not affected by treatment (P>0.05). The pattern of rumen fermentation changed from acetate to butyrate production with time after the morning feeding, reaching a peak value at 6 hours post-feeding, independent from the diet fed (data not shown). The diurnal patterns of all other volatile fatty acids followed the same pattern as of total volatile fatty acids (FIG. 2), indicating that the hour of measurement affected both concentrations and molar proportions of individual volatile fatty acids during the time after the morning feeding.

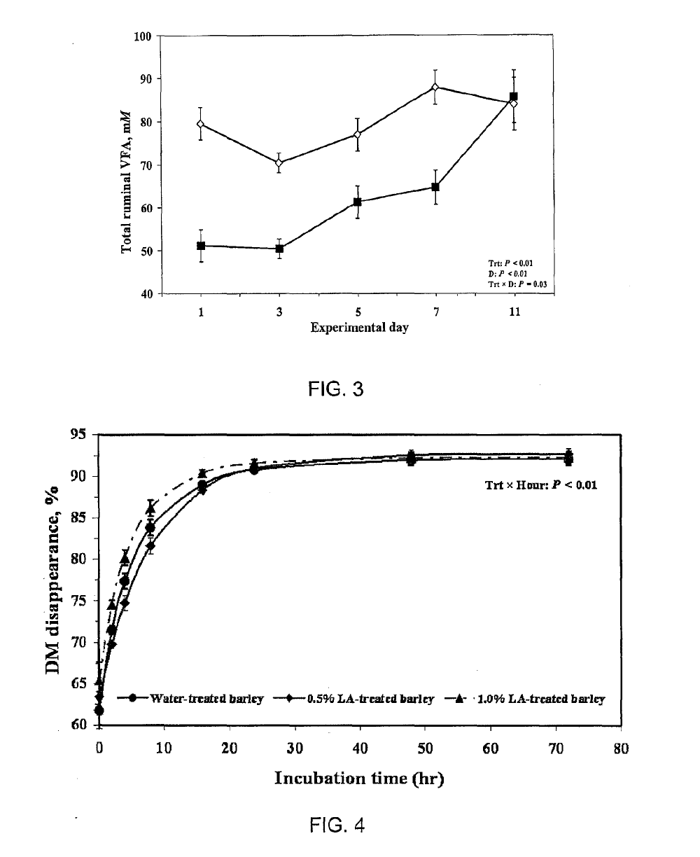

Results of day-to-day variations indicated greater concentration of pre-prandial volatile fatty acids in the rumen fluid of cows fed the control diet (P<0.01; FIG. 3). The concentrations of total volatile fatty acids were affected by the day of measurement (P<0.01) and there was an interaction between the treatment and day of sampling on the total concentration of volatile fatty acids (P=0.03; FIG. 3). Concentrations of acetate, isobutyrate, isovalerate, and caproate were also greater in cows fed the control diet (P<0.05), whereas other variables such as rumen propionate or acetate to propionate ratio were not affected by the treatment (Table 2). Molar percentages of acetate lowered (P=0.04), whereas those of propionate increased (P=0.09) when cows were fed the lactic acid-treated diet. Diet alone or in combination with the sampling day did not have an effect on pre-prandial rumen pH (Table 2).

TABLE 2
Day-to-day variation of pre-prandial rumen pH and concentrations of
VFA in lactating cows fed two different diets

| | Diets¹ | | | Effect,² P-value | | |
|---|---|---|---|---|---|---|
| Items³ | CTR | TRT | SEM | Trt | D | Trt × D |
| Ruminal pH | 7.06 | 7.05 | 0.03 | 0.91 | 0.03 | 0.78 |
| Individual VFA | | | | | | |
| mM | | | | | | |
| Acetate | 53.3 | 39.6 | 1.63 | <0.01 | <0.01 | 0.01 |
| Propionate | 14.9 | 13.6 | 0.88 | 0.32 | <0.01 | 0.05 |
| Butyrate | 7.36 | 5.99 | 0.54 | 0.09 | <0.01 | 0.13 |
| Isobutyrate | 1.10 | 0.83 | 0.04 | 0.01 | <0.01 | <0.01 |
| Valerate | 1.10 | 1.20 | 0.14 | 0.63 | <0.01 | 0.02 |
| Isovalerate | 1.62 | 1.24 | 0.11 | 0.03 | <0.01 | 0.24 |
| Caproate | 0.30 | 0.22 | 0.03 | 0.04 | 0.02 | <0.01 |
| % of total VFA | | | | | | |
| Acetate (A) | 67.0 | 63.9 | 0.97 | 0.04 | <0.01 | 0.01 |
| Propionate (P) | 18.8 | 21.4 | 1.03 | 0.09 | 0.08 | 0.11 |
| Butyrate | 9.07 | 9.22 | 0.40 | 0.80 | 0.06 | 0.42 |
| Isobutyrate | 1.40 | 1.34 | 0.05 | 0.38 | 0.87 | 0.03 |
| Valerate | 1.83 | 1.83 | 0.19 | 0.12 | 0.02 | 0.04 |
| Isovalerate | 2.05 | 1.99 | 0.15 | 0.77 | 0.95 | 0.80 |
| Caproate | 0.38 | 0.31 | 0.03 | 0.08 | 0.33 | <0.01 |
| A:P | 3.65 | 3.19 | 0.21 | 0.14 | 0.03 | 0.23 |

¹CTR = control diet containing rolled barley grain steeped for 48 h in equal quantity of tap water; TRT = treatment diet based on rolled barley grain steeped for 48 h in equal quantity of tap water containing 0.5% lactic acid (v/v).
²Effect of dietary treatment (Trt), measurement day (D), and treatment by day interaction (Trt × D).
³Data across d 1, 3, 5, 7, 9, and 11 of each measurement period (n = 8).

Without being bound to any theory, the above results suggest a modulatory effect of lactic acid on starch degradation characteristics (Engstrom et al., 1992). Typically, production and accumulation of volatile fatty acids in the rumen of cows fed barley gain causes a rapid fall in the rumen pH (Yang et al., 1997: Emmanuel et al., 2008). If the production rate of volatile fatty acids surpasses its absorption and neutralization rates, particularly during the intensive fermentation phases, and rumen pH remains below 5.8 for periods longer than four to five hours per day, then the risk of developing SARA is high (Zebeli et al., 2008). The lower concentration of volatile fatty acids in cows fed the lactic acid-treated diet may also be explained by a slower degradation rate of barley starch due to modulatory effects of lactic acid on rumen microflora. Without restriction to a theory, it is also believed that a direct effect of lactic acid-treated barley on is to increase the activity of amylolytic bacteria in the rumen, by providing a better growth environment for them. The results of the present invention showed a tendency for the lactic acid-treated diet to increase the molar proportion of propionate and decrease that of acetate in preprandial rumen fluid. Propionate derives from lactate through the reductive route, and utilization of acetate is necessary as a cofactor for conversion of lactate to propionate (Satter and Esdale, 1968).

Data showing the effects of feeding a control or lactic acid-treated diet on rumen degradation characteristics of the substrate (i.e., untreated rolled barley grain) are shown in Table 3. Cows fed the lactic acid-treated diet demonstrated greater ruminal in situ lag time of substrate DM degradation (P<0.01) and a tendency to lower the fractional degradation rate (P=0.10; Table 3).

TABLE 3
The kinetics parameters of DM disappearance of substrate¹ incubated
for 72 hours in the rumen of six lactating dairy cows fed two different diets

| | Diets² | | | |
|---|---|---|---|---|
| Parameters | CTR | TRT | SEM | P-value |
| Soluble fraction (a), % | 49.9 | 54.9 | 2.27 | 0.15 |
| Degradable fraction (b),³ % | 38.3 | 32.9 | 32.9 | 0.14 |
| Fractional degradation rate (k_{d}), %/h | 9.2 | 7.3 | 0.76 | 0.10 |
| Lag time, h | 6.17 | 9.33 | 0.41 | <0.01 |
| Effective degradability,⁴ % | 72.9 | 72.5 | 1.64 | 0.86 |
| Potential degradability, % | 88.2 | 87.9 | 0.87 | 0.10 |

¹The substrate incubated in duplicates in the Dacron bags consisted of untreated rolled barley grain.
²CTR = Diet based on rolled barley steeped in equal quantity of tap water for 48 h before feeding to the cows; TRT = Diet based on rolled barley steeped in 0.5% lactic acid (v/v) for 48 h before feeding to the cows.
³Insoluble, potentially degradable fraction.
⁴ERD, calculated using ruminal fractional rate of passage (kₛ) of 6%/h (ERD = a + b k_{d}/(k_{d} + kₛ).

Data from the in situ trial showing the DM disappearance of rolled barley grain or rolled barley grained steeped in two different lactic acid solutions are presented in Table 4. Results showed a quadratic effect of lactic acid on the effective rumen degradability (ERD) of the substrates. The ERD decreased from control to TRT1 but increased for TRT2 substrate (P=0.05, FIG. 4). The potentially degradable dry matter fraction tended to be quadratically lower in TRT1 substrate compared to the other two substrates (P=0.07). No effect of different substrate treatments was observed on the potential degradability of the substrates (P>0.05). The soluble fraction remained unaffected by different substrate treatments in the present study (P>0.05).

TABLE 4
The kinetics parameters of DM disappearance of different substrates
of rolled barley grain incubated with Dacron bags for 72 hours in the
rumen of six lactating dairy cows

| | Rolled barley | | | | Effect², | |
|---|---|---|---|---|---|---|
| | substrates¹ | | | | P-value | |
| Parameters | CTR | TRT1 | TRT2 | SEM | Linear | Square |
| Soluble fraction (a), % | 57.4 | 58.9 | 56.9 | 0.63 | 0.67 | 0.16 |
| Degradable fraction (b),³ | 34.7 | 33.7 | 35.3 | 0.43 | 0.34 | 0.07 |
| % | | | | | | |
| Degradation rate (k_{d}),⁴ | 18.6 | 12.3 | 21.2 | 3.86 | 0.64 | 0.13 |
| %/h | | | | | | |
| Effective degradability,⁵ | 82.4 | 81.5 | 83.6 | 0.42 | 0.12 | 0.05 |
| % | | | | | | |
| Potential degradability, | 92.0 | 92.6 | 92.3 | 0.33 | 0.72 | 0.44 |
| % | | | | | | |

¹Rolled barley substrates steeped for 48 h before incubating in the rumen in equal quantity of tap water (CTR) or in 0.5% (TRT1) and 1.0% (TRT2) lactic acid (v/v).
²Linear or quadratic effect of the treatment.
³Insoluble, potentially degradable fraction of DM.
⁴Fractional rate of disappearance of DM.
⁵ERD, calculated using ruminal fractional rate of passage (kₛ) of 6%/h (ERD = a + b k_{d}/(k_{d} + kₛ).

An interesting result of the in situ trial, which supported the in vivo data, was prolongation of the degradation lag time for rolled barley grain substrate incubated in the rumen of cows fed the lactic acid-treated diet. Degradation lag time of substrates rich in starch is crucial for the outcome of rumen fluid pH. The rapid fall in the rumen pH due to feeding of high-starch diets is believed to be related primarily to the diminution of diet degradation lag time in the rumen (Miller and Muntifering (1985)). Without being bound by any theory, prolonged degradation lag time might have contributed to better rumen pH values observed in cows fed the lactic acid-treated diet. Although the exact mechanism(s) how lactic acid treatment of barley grain lowers rumen degradability of starch has not yet been elucidated, it is consistent with a lower hydrolysis index for cereal starch treated with lactic acid.

Contrary to expectations, degradation rate of rolled barley grain treated with 1% lactic acid during the in situ trial, was greater compared with the 0.5% lactic acid-treatment. Although rolled barley treated with 1.0% lactic acid was tested only in situ, increased degradation rate by the latter treatment suggests the importance of lactic acid concentration on degradation of barley grain in the rumen. Studies using corn starch have shown that steeping corn grain in lactic acid improves solubility and recovery of matrix proteins and starch granules (Perez et al., 2001). Without being bound by any theory, the ability of lactic acid to disperse the protein matrix and increase starch recovery rate may become more significant with greater concentrations of lactic acid in solution.

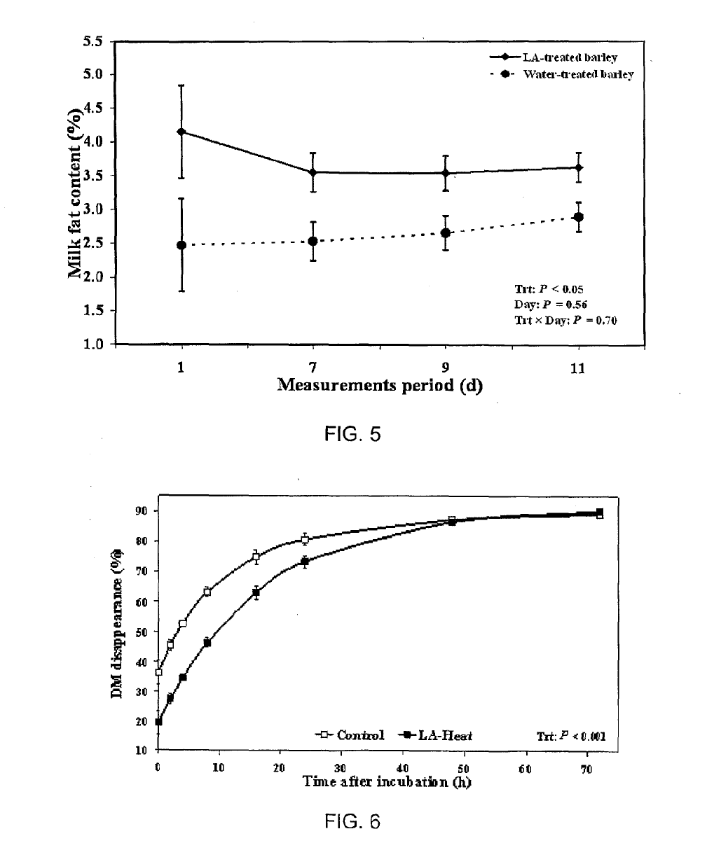

Data of dry matter intake (DMI), milk production and composition are shown in Table 5. Cows consumed about 16 to 18 kg DM/d; however, DMI was not different between treatments. Actual milk yield, FCM, and ECM were not affected by the treatment. The percentages and daily yields of milk protein, lactose, MUN, and SCC were also similar between the two diets (P>0.05). However, cows fed the lactic acid-treated diet increased milk fat content (P=0.04; Table 5; FIG. 5). The lactic acid-treated diet increased the fat:protein ratio in the milk (P=0.10). Cows fed the lactic acid-treated diet showed numerically higher milk fat yield, although the assumed tendency or significance levels were not reached (P>0.10). Treatment did not affect the energy intake and milk energy as well as the ratio between energy milk output and energy intake in this study (Table 5).

TABLE 5
Data of dry matter intake, milk production and composition as well as
production efficiency of lactating cows fed two different diets

| | Diets¹ | | | Effect,² P-value | | |
|---|---|---|---|---|---|---|
| Items | CTR | TRT | SEM | Trt | D | Trt × D |
| DMI, kg/d | 16.4 | 17.5 | 0.61 | 0.29 | 0.50 | 0.63 |
| Milk yield,³ kg/d | | | | | | |
| Milk | 22.6 | 23.3 | 1.24 | 0.71 | 0.16 | 0.74 |
| FCM⁴ | 20.0 | 22.1 | 1.33 | 0.23 | 0.37 | 0.53 |
| ECM⁵ | 20.7 | 22.3 | 1.13 | 0.41 | 0.52 | 0.62 |
| Fat | 0.59 | 0.79 | 0.06 | 0.13 | 0.17 | 0.84 |
| Protein | 0.68 | 0.73 | 0.04 | 0.46 | 0.18 | 0.84 |
| Lactose | 0.96 | 1.02 | 0.06 | 0.56 | 0.39 | 0.62 |
| Milk composition | | | | | | |
| Fat, % | 2.64 | 3.72 | 0.30 | 0.04 | 0.56 | 0.70 |
| Protein, % | 3.05 | 3.14 | 0.06 | 0.42 | 0.48 | 0.38 |
| Lactose, % | 4.45 | 4.39 | 0.07 | 0.61 | 0.23 | 0.39 |
| Fat:protein ratio | 0.88 | 1.12 | 0.09 | 0.10 | 0.17 | 0.96 |
| SCC, 10³ cells/mL | 62.9 | 94.6 | 44.0 | 0.64 | 0.17 | 0.58 |
| Milk urea N, mg/dL | 11.8 | 12.1 | 0.48 | 0.63 | 0.01 | 0.65 |
| Production efficiency | | | | | | |
| NE_{L} intake, Mcal/d | 26.6 | 28.3 | 1.01 | 0.32 | 0.51 | 0.63 |
| Milk energy,⁶ Mcal/d | 13.5 | 14.9 | 0.81 | 0.32 | 0.52 | 0.67 |
| NE_{L} intake output ratio | 0.50 | 0.54 | 0.04 | 0.53 | 0.32 | 0.81 |

¹CTR = control diet containing rolled barley grain steeped for 48 h in equal quantity of tap water; TRT = treatment diet based on rolled barley grain steeped for 48 h in equal quantity of tap water containing 0.5% lactic acid (v/v).
²Effect of dietary treatment (Trt), measurement day (D), and treatment by day interaction (Trt × D).
³Data across d 1, 7, 9, and 11 of the measurement period (n = 4).
⁴FCM = Milk amount (kg) * (0.4255 + 16.425 * % fat/100).
⁵ECM = Milk amount (kg) * (0.327 + 7.2 * % protein/100 + 12.96 * % fat/100).
⁶Milk energy (Mcal/kg milk) = 0.0929 * % fat + 0.0547 * % CP + 0.0359 * % lactose.

Since milk fat is related to the diet composition and metabolic processes in the rumen, this variable is often used as an indicator of rumen health and fiber adequacy in dairy cows (Zebeli et al., 2008). Rumen pH plays a key role with regard to milk fat content in dairy cows (Enjalbert et al., 2008). Strong associations exist between rumen pH and the amount of rumen endotoxin with milk fat content (Zebeli and Ametaj, 2009). Without being bound by any theory, the positive effect of the lactic acid-treated diet on milk fat content may be related to improved rumen pH and a better environment for rumen microbiota in cows fed the lactic acid-treated diet. There was no effect of dietary treatment on DMI, milk production, and other variables related to energy efficiency which agree with results reported by Peterson et al. (2003) who found no differences on the same variables during high-grain diet-induced milk fat depression.

The above results suggest that steeping rolled barley grain in 0.5% lactic acid modulated rumen fermentation patterns, increased rumen pH during the most critical phases of rumen fermentation, and enhanced milk fat content in late-lactating Holstein cows fed a 45% barley grain-based concentrate diet. The results also demonstrate the utilization of lactic acid-treated barley to decrease the risk of SARA and improve productivity when high proportions of barley grain are fed to lactating dairy cows.

Experiment 2 involved one in vivo and one in situ experiment to determine the effects of feeding barley grain treated with lactic acid and heat on rumen fermentation patterns, in situ dry matter (DM) degradation, milk production and composition, and day-to-day or diurnal variations of selected plasma metabolites in lactating dairy cows.

The in vivo trial involved eight rumen-fistulated Holstein cows that were fed once daily a total mixed ration containing rolled barley grain (32.8% in DM basis) steeped in an equal quantity of tap water (control or “CTR”) or 1% lactic acid (LA) and oven-heated at 55° C. for 48 hours (“LAH-treated diet” or “TRT”) in a 2×2 crossover design. The in situ trial involved incubation in the rumen for 72 hours of three different substrates in cows fed the control or the LAH-treated diet. The in situ bags contained either rolled barley grain steeped in tap water (CTR1) or rolled barley grain steeped in 1.0% LA and oven-heated at 55° C. for 48 hours (TRT1 and TRT2 respectively).

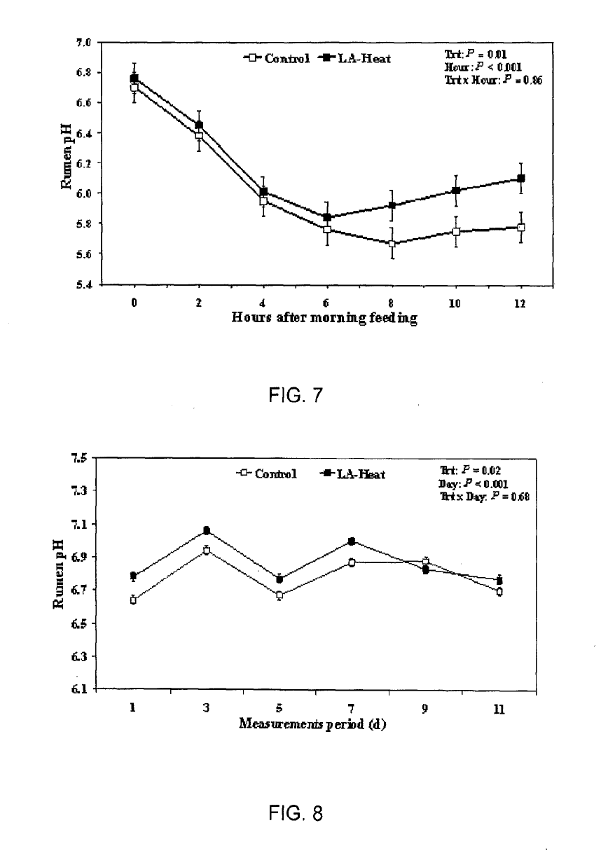

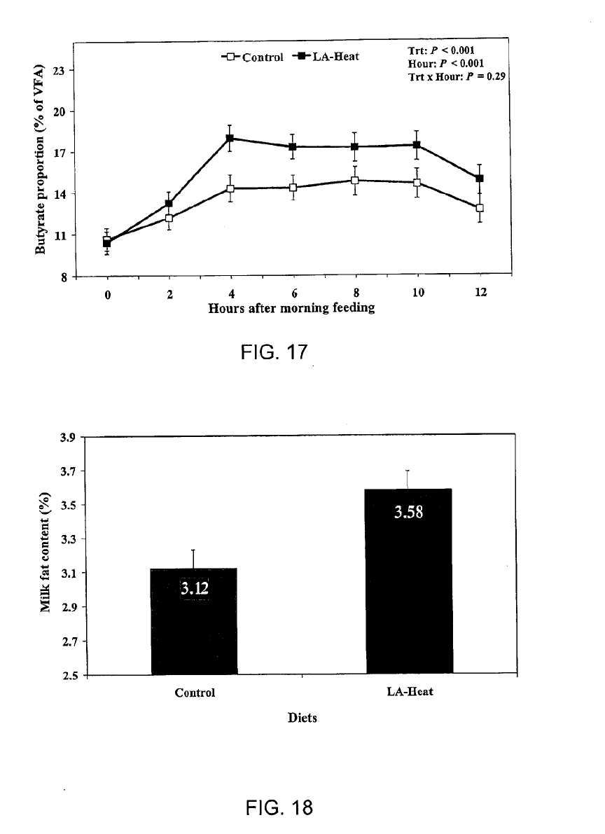

The in vivo results showed higher (P=0.01) rumen pH particularly at the nadir for cows fed the LAH-treated diet (FIG. 7). Cows fed the LAH-treated diet also showed higher pre-prandial rumen pH (FIG. 8). Cows fed the LAH-treated diet had greater rumen acetate and butyrate (P<0.001 and P<0.001, respectively) and lower rumen propionate (P<0.001) (FIGS. 16 and 17). Although dry matter intake and milk production did not change between the groups, cows fed the LAH-treated diet showed greater amounts of fat-corrected milk (P=0.06; FIG. 10) due to a higher milk fat content (3.12 vs. 3.58%) of the LAH-treated diet. The in situ data showed that cows fed the LAH diet had lower DM disappearance of barley grain substrate from 0 hours (19.4 vs. 36.5%) up to 24 hours (73.4 vs. 80.7%; FIG. 6) post-incubation. However, DM disappearance rates were equal in both treatments starting at 48 hours (P=0.59) until 72 hours (P=0.47) post-incubation.

The in vivo results thus revealed that feeding dairy cows the LAH-treated diet maintained rumen pH above SARA levels at the most critical hours after the morning feeding (i.e., 8-12 hours post-feeding). Without being bound to any theory, LAH-treated diet might modify starch structure to confer resistance to rumen degradation. This may be supported by the in situ data which demonstrated that the DM disappearance rate of LAH-treated barley grain in the rumen in the first 24 hours after incubation was lower compared to the control diet. In addition, measurement of volatile fatty acids indicated that concentrations of total volatile fatty acids in the rumen fluid were greater in the control group during 2, 4, 8 and 10 hours post-feeding compared with the LAH-treated group. Patterns of rumen volatile fatty acids are in agreement with those of rumen pH between the two groups and fully support greater rumen pH values obtained in the group of cows fed the LAH-treated diet. It is known that the main contributors in the acidification of rumen fluid are volatile fatty acids released during starch degradation. The above results indicate that the LAH-treated diet slowed down digestion of barley grain and the release of volatile fatty acids, thus maintaining the rumen pH above SARA levels.

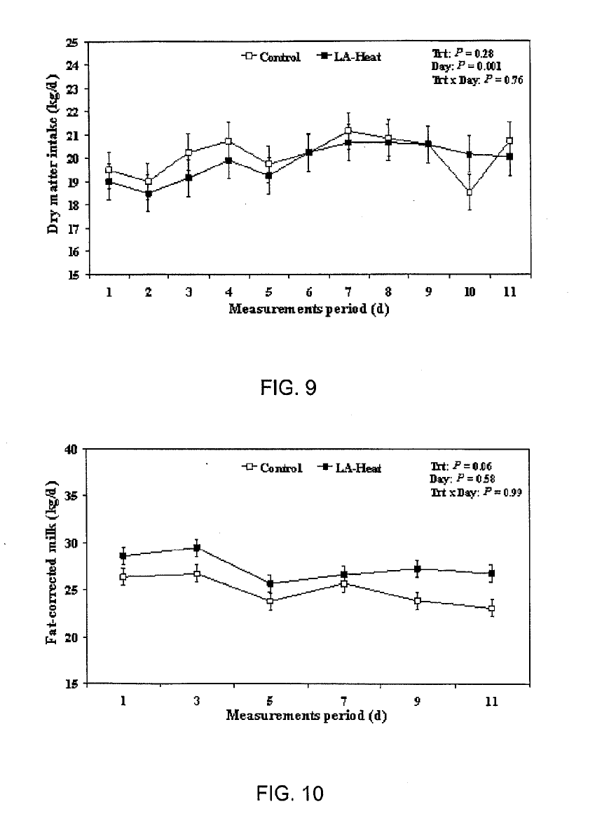

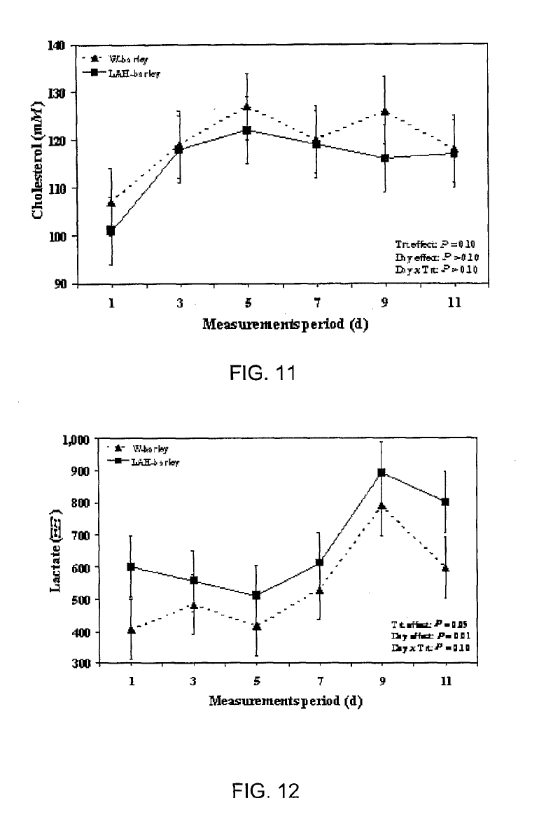

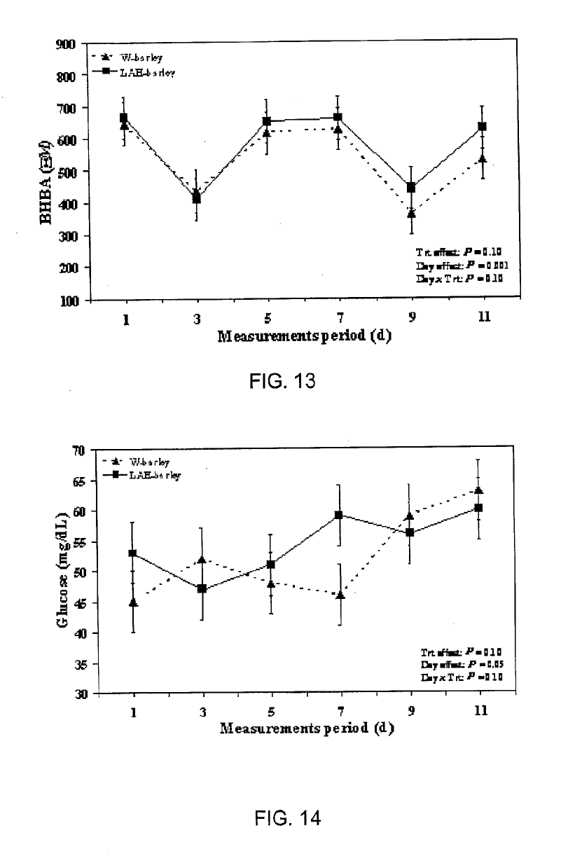

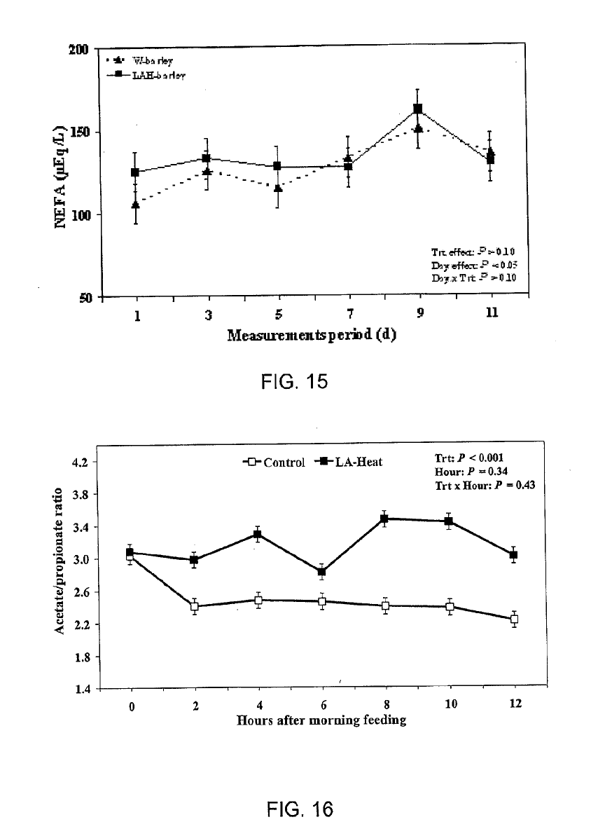

Day-to-day data showed that dry matter intake (DMI) was not affected by treatment (FIG. 9). However, the LAH-treated diet tended to decrease the overall pre-prandial plasma cholesterol (P<0.05; FIG. 11) and increased circulating plasma lactate (FIG. 12). There were no effects on BHBA, glucose, and NEFA (FIGS. 13, 14, and 15). All plasma metabolites except cholesterol changed in relation to the day of sampling.

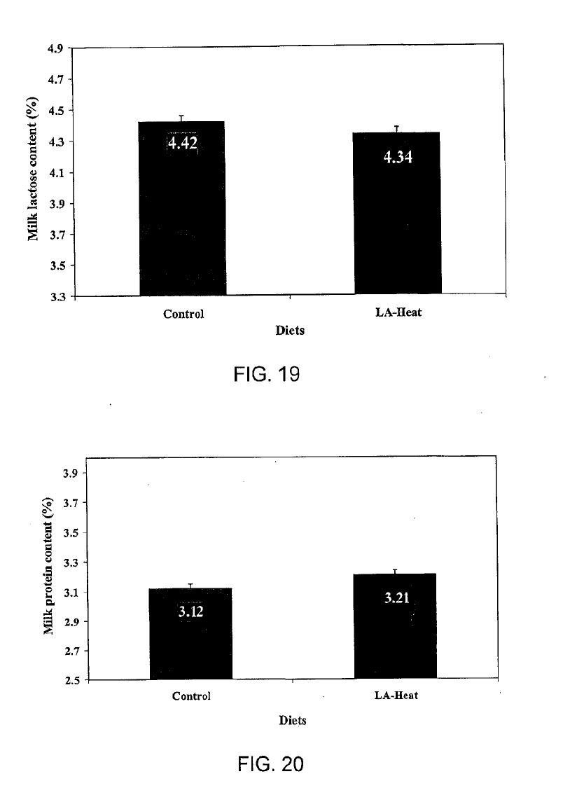

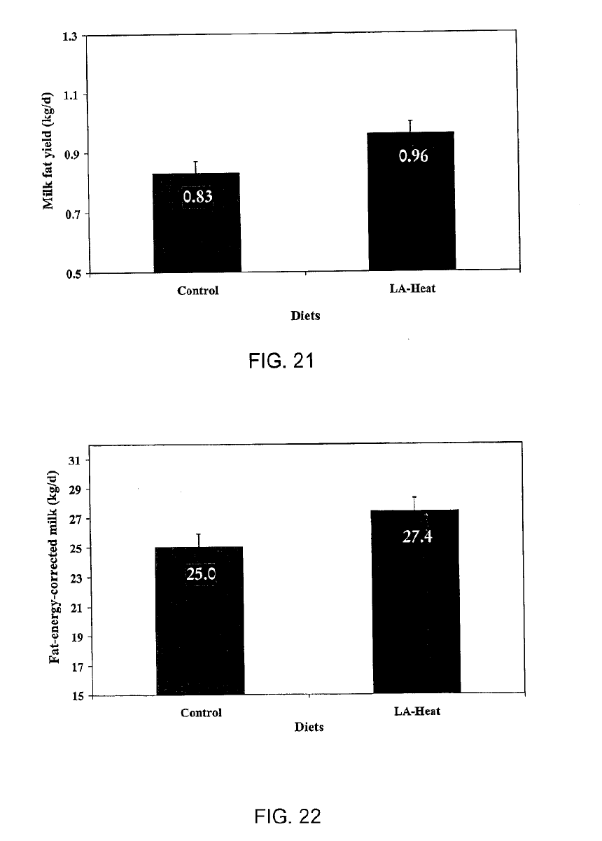

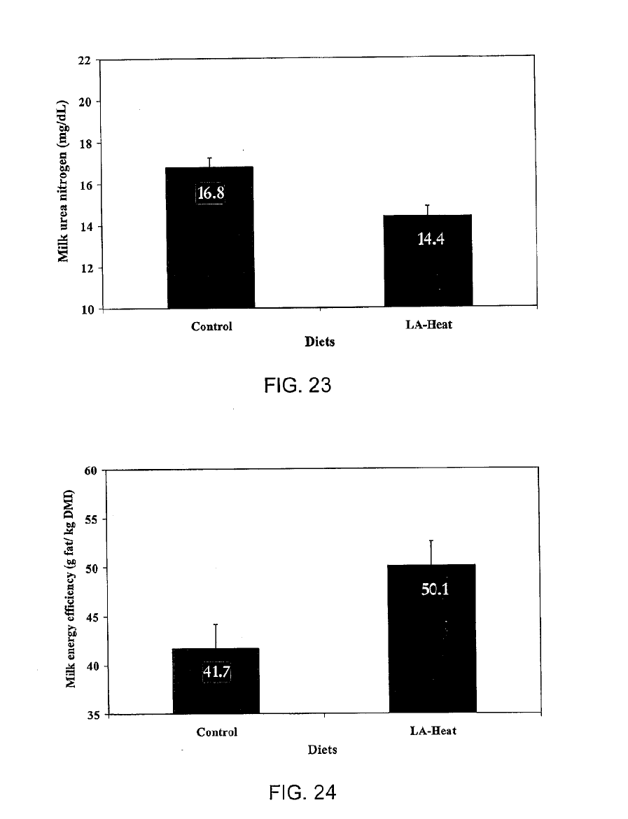

Although the LAH-treated diet did not affect DM intake and milk production, the LAH-treated diet was associated with increased milk fat content, milk fat yield, fat-corrected milk, and milk energy efficiency (FIGS. 18-24). These results demonstrate potential utilization of LAH-treated diet to increase the feeding value of barley grain and the productivity of dairy cows fed high proportions of cereal grain. This may greatly benefit the dairy industry whose profit is based upon the amount of milk produced and the content of fat in the milk.

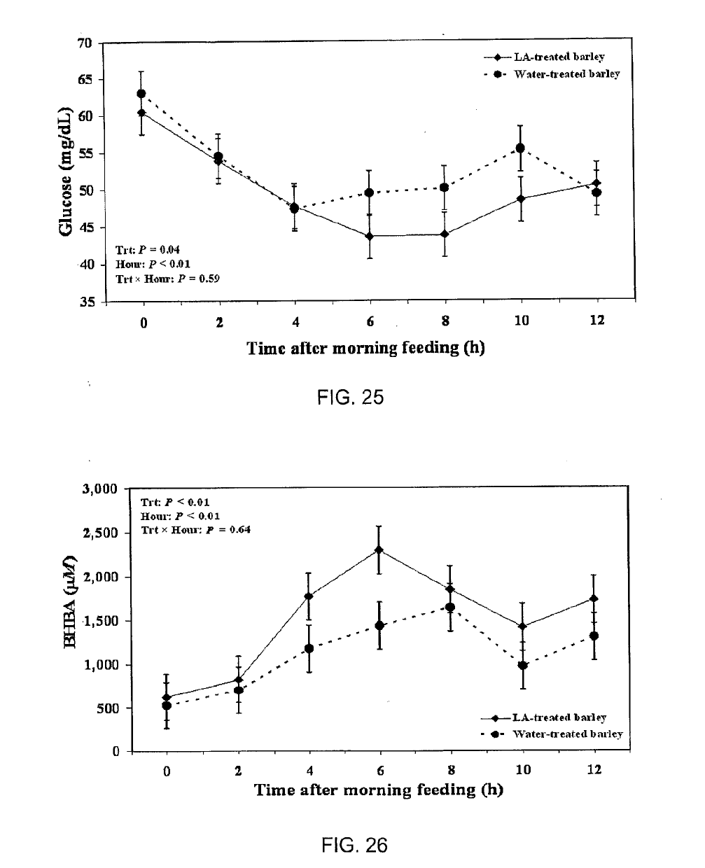

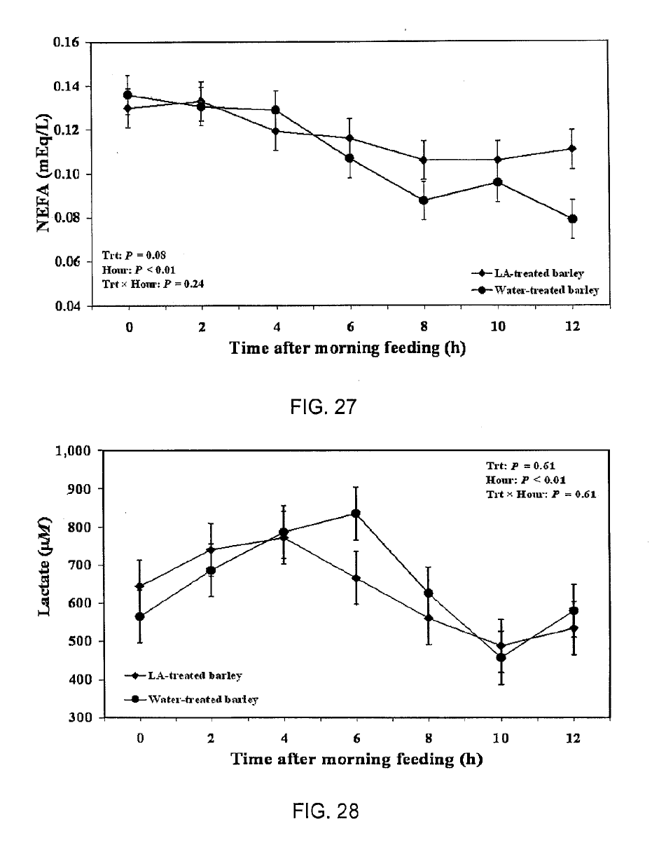

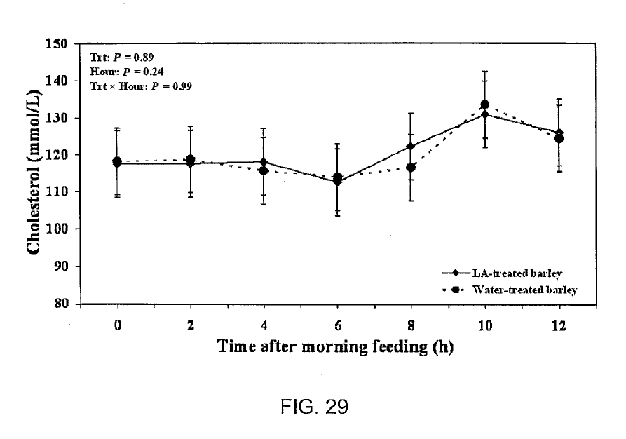

The effects of feeding barley grain treated with water or lactic acid and heat on diurnal patterns of plasma metabolites in lactating dairy cows were determined. Both plasma glucose and BHBA were modulated by the lactic acid-treated rolled barley grain (P<0.05). The LAH-treated diet was associated with decreased plasma concentration of glucose (P<0.04) and increased plasma BHBA (P<0.01; FIGS. 25 and 26). The time after feeding also affected both plasma glucose and BHBA (P<0.01). However, the effect was more pronounced at 8 and 10 hours post-feeding for glucose and at 6 hours for BHBA. Feeding the LAH-treated diet increased the overall circulating NEFA (P<0.08), particularly at 12 hours post-feeding (FIG. 27). No differences in the diurnal patterns of plasma lactate (P<0.61) and cholesterol (P<0.89) were observed (FIGS. 28 and 29). The concomitant increase of both plasma BHBA and NEFA, and the decrease of plasma glucose during feeding of relatively high proportions of rolled barley grain treated with LAH indicates that the diurnal patterns of selected plasma metabolites in late-lactation dairy cows may be modulated.

The above results indicate that feeding LAH-treated diet maintained rumen pH at greater values than the control diet, slowed down degradation of barley grain in the rumen and the amount of volatile fatty acids in the rumen, and modulated pre-prandial and diurnal patterns of several plasma metabolites.

Exemplary embodiments of the present invention are described in the following Examples, which are set forth to aid in the understanding of the invention, and should not be construed to limit in any way the scope of the invention as defined in the claims which follow thereafter.

### Example 1

### Animals and Diets

All experimental procedures were approved by the University of Alberta Animal Care and Use Committee for Livestock, and animals were cared for in accordance with the guidelines of the Canadian Council on Animal Care (1993) and with veterinary supervision. Eight ruminally cannulated (Ø 100 mm, Bar Diamond, ID) primiparous Holstein cows were used. The cows were at 198 to 236 DIM, had an average milk production of 28 kg/d, and weighed 680±30 kg. The cows were assigned to one of the two dietary treatments according to a paired 2×2 crossover design with two study-periods. Each experimental period was 21 days, with first 10 days used for adaptation to diets and 11 days for experimental measurements.

For Experiment 1, cows were offered a total mixed ration containing 15% alfalfa hay, 40% barley silage, and 18% energy and protein supplement. In addition, 27% (dry matter basis) rolled barley grain, steeped in equal quantity (by weight) of either tap water alone (control or “CTR”) or of 0.5% lactic acid solution (“TRT”), was added to the total mixed ration just prior to the morning feeding.

For Experiment 2, cows were offered a total mixed ration containing 15% alfalfa hay, 40% barley silage, and 18% energy and protein supplement. In addition, 32.8% (dry matter basis) rolled barley grain, steeped in equal quantity (by weight) of either tap water alone (control or “CTR”) or 1.0% lactic acid solution and oven-heated at 55° C. for 48 h (“LAH” or “TRT”), was added to the total mixed ration just prior to the morning feeding.

The steeping time of rolled barley was 48 h before being mixed to the total mixed ration. The lactic acid (DL lactate, 85%, w/w) was purchased from Sigma (Ontario, Canada). The diets were formulated to meet or exceed the requirements of a 680-kg lactating cow producing about 25 kg milk/d with 3.5% fat as per NRC (2001) guidelines. The cows were fed for ad libitum intake to permit at least 5% orts. The cows were housed in individual tie stalls bedded with sawdust, and had free access to water. Diets were fed once daily at 0800 h. Estimated CP and NE_{L} contents were similar across different diets. Ingredients and estimated chemical composition of the experimental diets are presented in Table 6.

TABLE 6
Ingredients and estimated chemical
composition of experimental diets

| | Diets¹ | |
|---|---|---|
| Ingredients, % of DM | CTR | TRT |
| Alfalfa hay | 15.0 | 15.0 |
| Barley silage | 40.0 | 40.0 |
| Rolled barley grain (water-treated) | 27.0 | — |
| Rolled barley grain (LA-treated) | — | 27.0 |
| Ground barley grain | 4.96 | 4.96 |
| Canola meal | 1.21 | 1.21 |
| Corn gluten meal | 7.81 | 7.81 |
| Canola oil | 0.45 | 0.45 |
| Biofos² | 0.22 | 0.22 |
| Dairy premix³ | 0.76 | 0.76 |
| Limestone | 0.90 | 0.90 |
| Sodium bicarbonate | 0.67 | 0.67 |
| Molasses | 0.67 | 0.67 |
| Mg oxide | 0.18 | 0.18 |
| Vitamin E (5,000 IU/kg) | 0.03 | 0.03 |
| Vitamin D₃ (500,000 IU/kg) | 0.18 | 0.18 |
| Nutrient composition, % of DM unless stated | | |
| DM | 57.8 | 57.8 |
| Ash | 6.00 | 6.00 |
| CP | 16.6 | 16.6 |
| EE | 3.20 | 3.20 |
| NFC⁴ | 45.2 | 45.2 |
| NDF | 29.0 | 29.0 |
| Forage NDF | 21.2 | 21.2 |
| ADF | 17.0 | 17.0 |
| NE_{L}, Mcal/kg DM | 1.62 | 1.62 |
| Ca | 0.80 | 0.80 |
| P | 0.40 | 0.40 |
| DCAD, Meq/kg | 104 | 104 |

¹CTR = control diet containing rolled barley grain steeped for 48 h in equal quantity of tap water; TRT = treatment diet based on rolled barley grain steeped for 48 h in equal quantity of tap water containing 0.5% lactic acid (LA; v/v).
²Contained monocalcium phosphate and dicalcium phosphate in the ratio 2:1.
³Contained Calcium 0.1%, Phosphorous 0.6%, Sodium 11.5%, Magnesium 0.3%, Potassium 0.7%, Sulphur 0.23%, Zinc 5000 mg/kg, Copper 1170 mg/kg, Manganese 3100 mg/kg, Iodine 80 mg/kg, Cobalt 6.2 mg/kg, Vitamin A 1265000 IU/kg, Vitamin D 142000 IU/kg, Vitamin E 3800 IU/kg.
⁴Non-fiber carbohydrates = 100 − (% NDF + % CP + % EE + % Ash).

### Example 2

### In Vivo Ruminal Fermentation

To evaluate the effects of treatment on in vivo rumen fermentation, the pH and VFA concentration in the rumen fluid were measured. About 250 mL of the ruminal fluid was collected on days 1, 3, 5, 7, and 11 of the measurements period. In addition, on the last day (i.e., day 11), rumen fluid samples were taken every two hours starting from 0800 until 2000 to investigate the diurnal responses. Rumen fluid samples were collected in the ventral rumen sac through the cannula using a tube fitted with a stainer and syringe into a 140-m1 plastic container. Ruminal fluid pH was measured by a mobile pH meter (Accumet AP61, Fischer Scientific, Ottawa, Ontario, Canada) immediately after sample collection. To evaluate the effect of treatment on the risk of SARA, the duration time in which ruminal pH was <5.8 during the time from 0 to 12 h post-feeding was also estimated assuming an exponential function of pH curve between two adjacent time points. For VFA analysis, about 100 mL of ruminal fluid was centrifuged at 2,010×g for 20 min in 4° C. (Rotanta 460 R, Hettich Zentrifugan, Tuttlingen, Germany), and two replicates of supernatant, five milliliters each, were stored at −20° C. until analyzed to determine VFA concentrations. Ruminal VFA were separated and quantified using gas chromatography (Varian 3700; Varian Specialties Ltd., Brockville, Ontario, Canada) using a 15-m (0.53-mm i.d.) fused silica column (DB-FFAP column; J & W Scientific, Folsom, Calif.).

### Example 3

### In Situ Degradation Trial

To evaluate the kinetics of dry matter (DM) degradation, duplicate samples of barley grain were used as substrates for incubation in the rumen of six cows, and variables of its in situ DM disappearance were used as indices of degradation kinetics. In addition to the control (“CTR”) substrate, rolled barley substrates steeped in 0.5% or 1.0% lactic acid (TRT1 and TRT2, respectively) were also incubated to test the effect of a higher concentration of lactic acid on in situ degradation kinetics. To evaluate the effects of diet on degradation characteristics of the rumen, untreated rolled barley grain (i.e., not steeped in water) was incubated in the rumen of cows fed the CTR and TRT diets, and parameters of the in situ degradation kinetics were evaluated.

In both in situ trials, the total incubation time in the rumen was 72 h. Samples of approximately 4 g of all substrates were dried at 60° C. for 72 h and ground to pass through a 2 mm screen. Subsequently, the samples were transferred in Dacron polyester bags (5×10 cm) with a pore size of 52±5 μm (mean±SD) and incubated in duplicates in the rumen. The bags were soaked in warm water for 10 min before insertion into the rumen in order to simulate the saliva addition. Bags were placed in large mesh retaining sacs before being incubated and then placed in the rumen for 0 (water-washed, but not incubated in the rumen), 2, 4, 8, 16, 24, 48, and 72 h.

After removal from the rumen, bags were washed under cold, running tap water followed by the machine-washing using the procedure described by Cherney et al. (1990) and dried at 60° C. for 48 h. Variables of in situ kinetics of DM disappearance of the substrates were estimated using the NUN procedure of SAS (SAS Institute, 2003) according to the following model (McDonald, 1981):

Y=a+b×(1−e^{-k}^{_{d}}^{(t-L)}) for t>L [1]

where a is the soluble fraction (%); b is the insoluble, potentially degradable fraction (%); k_{d} is the fractional rate of disappearance (%/h); L is the lag time (h); and t is the time of incubation (h). The effective rumen degradability (ERD) was calculated assuming a fractional passage rate (kₛ) of 6%/h using the following equation:

ERD=a+bk_{d}/(k_{d}+kₛ) [2]

### Example 4

### Feed Intake and Milk Composition

Individual feed intake and milk production was recorded daily during the last 11 days of the measurements period. Feed intake was calculated by the difference between the total daily feed given to each cow with that of the feed refusals of the next morning. Milk samples were collected on days 1, 7, 9, and 11, at 0500 and 1500, and were analyzed for milk fat, CP, MUN, SCC, and lactose contents by mid-infrared spectroscopy (MilkoScan 605; A/S N Foss Electric, Hillerød, Denmark) at Central Milk Testing Laboratory (Edmonton, Alberta). Daily milk energy output was estimated from measured milk yield and concentrations of milk fat, CP, and lactose according to the NRC (2001) equation:

NE_{L}(Mcal/kg milk)=0.0929*fat %+0.0547*protein %+0.0395*lactose % [3]

The ratio of NE_{L} milk output:NE_{L} intake was calculated to evaluate the effect of dietary treatment on milk energy efficiency

### Example 5

### Plasma Metabolites

In Experiment 2 for the analysis of day-to-day variations of selected plasma metabolites, blood samples were collected at 0730 from the tail vein on days 1, 3, 5, 7, 9 and 11. For the analysis of diurnal patterns of selected plasma metabolites, blood samples were collected on the last day of each measurement period at 0 (i.e. before the morning feeding), 2, 4, 6, 8, 10 and 12 hours post-feeding. Plasma glucose, beta-hydroxybutyrate, lactate, cholesterol, and non-esterfied fatty acids were measured using standard techniques. Dry matter intake was recorded daily from each cow.

### Example 6

### Statistical Analyses

All data were analyzed using the MIXED procedure of SAS (SAS Institute Inc., Version 9.1.3). For each response variable tested, the model included the fixed effects of period, sequence, measurement time (i.e., day or hour), and treatment as well as the resulting two-way interaction of the latter two factors. Cow within sequence was considered as random effect. Measurements collected at different times on the same cow were considered as repeated measures in the ANOVA. The variance-covariance structure of the repeated measures was modeled separately for each response variable according to the lowest values of the fit statistics based on the Bayesian information criteria and an appropriate structure was fitted. Degrees of freedom were approximated by the method of Kenward-Roger (ddfm=kr). Linear and quadratic effects of the treatment on in situ data were determined using the orthogonal contrasts. LSM and the respective SEM were computed. Significance was declared at P≦0.05, while a tendency was considered up to 0.05<P≦0.01. Because the effect of sequence was significant at P<0.05 for variables of milk production and composition, their baseline measurements taken just before starting of the experiment were used as covariates in the model of ANCOVA for the latter variables. Therefore, only data from the first period were used for their analysis as described recently by Shen (2006). Other features of the model were the same as explained for the ANOVA.

As will be apparent to those skilled in the art, various modifications, adaptations and variations of the foregoing specific disclosure can be made without departing from the scope of the invention claimed herein.

### REFERENCES

The following references are incorporated herein by reference (where permitted) as if reproduced in their entirety. All references are indicative of the level of skill of those skilled in the art to which this invention pertains.
Ametaj, B. N., B. J. Bradford, G. Bobe, R. A. Nafikov, Y. Lu, J. W. Young, and D. C. Beitz. 2005. Strong relationships between mediators of the acute phase response and fatty liver in dairy cows. Can. J. Anim. Sci. 85:165-175.
Canadian Council on Animal Care. 1993. Guide to the care and use of experimental animals. Vol. 1. 2^{nd} ed. CCAC, Ottawa, Ontario, Canada.
Cherney, D. J. R., J. A. Paterson, and R. P. Lemenager. 1990. Influence of in situ bag rinsing technique on determination of dry matter disappearance. J. Dairy Sci. 73:391-397
Dehghan-Banadaky, M., R. Corbett, and M. Oba. 2007. Effects of barley grain processing on productivity of cattle. Anim. Feed Sci. Technol. 137:1-24.
Emmanuel, D. G. V., S. M. Dunn, and B. N. Ametaj. 2008. Feeding high proportions of barley grain stimulates an inflammatory response in dairy cows. J. Dairy Sci. 91:606-614.
Engstrom, D. F., G. W. Mathison, and L. A. Goonewardene. 1992. Effect of glucan, starch and fibre content of barley grain on its digestion and utilization by steers. Anim. Feed Sci. Technol. 37:33-46.
Enjalbert, F., Y. Videau, M. C. Nicot, and A. Troegeler-Meynadier. 2008. Effects of induced subacute ruminal acidosis on milk fat content and milk fatty acid profile. J. Anim. Physiol. Anim. Nutr. 92:284-291.
Krause, K. M., and G. R. Oetzel. 2006. Understanding and preventing ruminal acute acidosis in dairy herds: A review. Anim. Feed Sci. Technol. 126:215-236.
Liljeberg, H. G. M., C. H. Lonner, and I. M. E. Bjorck. 1995. Sourdough fermentation or addition of organic acids or corresponding salts to bread improves nutritional properties of starch in healthy humans. J. Nutr. 125:1503-1511.
Mao, S. Y., G. Zhang, and W. Y. Zhu. 2006. Effect of disodium fumarate on ruminal metabolism and rumen bacterial communities as revealed by denaturing gradient gel electrophoresis analysis of 16S ribosomal DNA. Anim. Feed Sci. Technol. 140:293-306.
McDonald, I. 1981. A revised model for the estimation of proteindegradability in the rumen. J. Agric. Sci. 96:251-252.
Miller, B. G., and R. B. Muntifering. 1985. Effect of forage:concentrate on kinetics of forage fiber digestion in vivo. J. Dairy Sci. 68:40-44.
Nocek, J. E. 1997. Bovine acidosis: implications on laminitis. J. Dairy Sci. 80:1005-1028.
Nordlund, K. V., and E. F. Garrett. 1994. Rumenocentesis: A technique for collecting rumen fluid for the diagnosis of subacute rumen acidosis in dairy herds. Bovine Pract. 28:109-112.
NRC. 2001. Nutrient Requirements of Dairy Cattle. 7^{th} rev. ed. Natl. Acad. Sci., Washington, D.C.
Östman, E. M., M. Nilssont, H. G. M. Lilberg, G. Molin, and I. M. E. Björck. 2002. On the effect of lactic acid on blood glucose and insuline responses to cereal products: Mechanistic studies in healthy subjects and in vitro. J. Cereal Sci. 36:339-346.
Perez, O. E., M. Haros, and C. Suarez. 2001. Corn steeping: influence of time and lactic acid on isolation and thermal properties of starch. J. Food Eng. 48:251-256.
Peterson, D. G., E. A. Matitashvili, and D. E. Bauman. 2003. Diet-induced milk fat depression in dairy cows results in increased trans-10, cis-12 CLA in milk fat and coordinate suppression of mRNA abundance for mammary enzymes involved in milk fat synthesis. J. Nutr. 133:3098-3102.
SAS Institute. 2003. SAS User's Guide: Statistics, Release 9.1.3. SAS Inst. Inc., Cary, N.C.
Satter, L. D., and W. J. Esdale. 1968. In vitro lactate metabolism by ruminal ingesta. Appl. Microbiol. 16:680-688.
Shen, D. 2006. Estimate carryover effect in clinical trial crossover designs. SAS Conf. Proc., PharmaSUG, May 21-24, 2006, Bonita Springs, Fla.
Stone, W. C. 2004. Nutritional approaches to minimize subacute ruminal acidosis and laminitis in dairy cattle. J. Dairy Sci. 87 (E. Suppl.):E12-E26.
Yang, W. Z., K. A. Beauchemin, K. Koenig, and L. M. Rode. 1997. Effects of barley, hulless barley, and corn in concentrates on site and extent of digestion by lactating cows. J. Dairy Sci. 80:2885-2895.
Zebeli, Q., J. Dijkstra, M. Tafaj, H. Steingass, B. N. Ametaj, and W. Drochner. 2008. Modeling the adequacy of dietary fiber in dairy cow based on responses of ruminal pH and milk fat production to composition of the diet. J. Dairy Sci. 91:2046-2066.
Zebeli, Q., and B. N. Ametaj. 2009. Relationships between rumen lipopolysaccharide and mediators of inflammatory response with milk fat production and efficiency in dairy cows. J. Dairy Sci. (in press).

1. A method of producing a ruminant feed comprising cereal grain, the method comprising the step of treating the cereal grain with a weak organic acid.

2. The method of claim 1 wherein the weak organic acid comprises acetic acid, ascorbic acid, citric acid, lactic acid, malic acid, sorbic acid or tartaric acid.

3. The method of claim 1 wherein the weak organic acid comprises lactic acid.

4. The method of claim 3 wherein the cereal grain is steeped in a solution comprising about 0.5% to about 1.0% by volume of lactic acid.

5. The method of claim 1 further comprising the step of heating the cereal grain.

6. The method of claim 5 wherein the cereal grain is heated at a temperature of 55° C.

7. The method of claim 5, wherein the cereal grain is heated for 48 hours.

8. The method of claim 1, wherein the cereal grain comprises barley, wheat, corn, oats, sorghum, or millet.

9. The method of claim 8, wherein the cereal grain comprises barley.

10. The method of claim 1, wherein ruminant feed comprises the cereal grain admixed with one or more ingredients selected from fibrous cellulosic materials, forage, legume forage, nitrogen sources, protein precursors, high energy sources, flavorings, vitamins, or minerals.

11. The method of claim 10, wherein the ruminant feed comprises 1-35% in dry matter cereal grain.

12. The method of claim 10, wherein the wherein the ruminant feed comprises 25-35% in dry matter cereal grain.

13. A ruminant feed produced by the method of claim 1.

14. A method of preventing rumen acidosis and/or increasing milk fat content in a dairy cow comprising the step of feeding the dairy cow the ruminant feed of claim 13.

15. The method of claim 14 wherein the ruminant feed is provided to the dairy cow during lactation.
